(19) United States
(12) Patent Application Publication
(10) Pub. No.: US 2017/0077988 A1
(43) Pub. Date: Mar. 16, 2017

(54) METHOD AND DEVICE FOR SIMULTANEOUS UPSTREAM AND DOWNSTREAM MEASUREMENTS IN CABLE TV NETWORKS

(71) Applicant: Viavi Solutions Inc., Milpitas, CA (US)

(72) Inventor: Robert J. Flask, New Palestine, IN (US)

(21) Appl. No.: 14/856,318

(22) Filed: Sep. 16, 2015

(51) Int. Cl. H04B 3/46; H04L 1/20

(52) U.S. Cl. CPC H04B 3/46; H04L 1/203

(57) ABSTRACT

A cable network tester includes separate ports for receiving downstream and upstream signals, and separate signal processing circuitry for parallel processing the downstream and upstream signals. Results of the upstream and downstream testing, including upstream and downstream frequency scans and other tests related to incoming subscriber services and home wiring integrity, may be simultaneously displayed in real time. The tester may be configured for automatic port connection detection and routing.

### TECHNICAL FIELD

The present disclosure generally relates to testing and monitoring of cable TV networks, and more particularly relates to devices and methods for simultaneous upstream and downstream measurements in a cable TV network.

### BACKGROUND

A cable network delivers services such as digital television, Internet, and Voice-over-IP (VoIP) phone connection. A typical cable network is a two-way hybrid fiber-coaxial (HFC) network that supports point-to-multipoint transmission in the downstream direction using digital signals or a mix of analog and digital signals, and multipoint-to-point transmission in the upstream direction. Downstream signals, which carry broadcast digital TV signals, internet traffic, etc., are distributed via a fiber optic connection from a head-end to a node that converts the optical signal to an electrical signal and then distributes the signals to residences via a tree and branch coaxial cable distribution network termed ‘cable plant’. At the subscriber side, terminal equipment supports the delivery of cable services, which may include video, data and voice services, to subscribers via cable modems. Upstream signals from the subscribers' homes carry phone and Internet traffic. The upstream signals propagate from the branches of the cable plant towards the headend of the network.

Delivery of data services over cable networks is typically compliant with a Data Over Cable Service Interface Specifications (DOCSIS®) standard. The term ‘DOCSIS’ generally refers to a group of specifications published by CableLabs that define industry standards for cable headend equipment, such as Cable Modem Termination System (CMTS), and cable modem (CM) equipment. The physical layer specification of DOCSIS provides for the use of frequency multiplexing and several specific forms of quadrature amplitude modulation (QAM) for both upstream (CM to headend) and downstream (headend to CM) communications. Upstream and downstream signals occupy separate frequency bands called upstream and downstream frequency bands. Downstream information channel signals co-propagate in the downstream frequency band, and upstream signals co-propagate in the upstream frequency band. The frequency separation of the upstream and the downstream signals allows bidirectional amplification of these signals, which propagate in a common cable in opposite directions. In the United States, most of the cable equipment installed at the time of the writing complies with the DOCSIS 3.0 version of the DOCSIS standard, which provides for the upstream spectral band from 5 MHz to 42 MHz typically, with the downstream channels using 64-QAM or 256-QAM modulation format and 6 MHz spacing within the downstream spectral band spanning from 50 MHz to 1000 MHz. The upstream channel widths are configurable and may take a set of define values between 200 kHz and 6.4 MHz, each corresponding to a specific symbol rate, with the upstream data modulated with either QPSK, 16-QAM, 32-QAM, 64-QAM or 128-QAM.

The upstream and downstream signals are prone to impairments that may originate at a plurality of network locations in the network. As the result of the “tree” structure of the cable plant, there may be numerous devices, cable segments and connectors located between the fiber optic node and the end user. This provides for a plurality of locations were a defect can occur, resulting in either no service or a reduced service to the end user. In order to ensure adequate performance, the cable plant needs to be monitored and tested and the source of impairments identified and located. Tracing the source of impairment typically requires that a technician travels to different network locations and compares measurements to locate the impairment. Portable network testing devices currently used in the industry may help to identify certain types of defects in the cable plant by performing specific spectral and noise measurements in the upstream and/or downstream directions using specialized testing methods at different network locations. A number of tests can also be performed to evaluate quality of digital TV signal transmission on higher logical levels of data transmission, for example by measuring such parameters as carrier level or amplitude, modulation error ratio (MER), bit error rate (BER), ingress under carrier (IUC), and other parameters. The measurements may be performed on channel-by-channel basis, each channel diagnostic data being summarized on a separate screen or data page viewed by the technician on the tester's visual display. In many cases, both upstream and downstream services and/or signals may need to be tested. In a typical scenario, a technician may travel to a specific network location, such as to the location of a customer tap if there is a need to provision a new service to the customer or to identify a source of a service impairment, and separately test downstream services provided to the customer, and customer's network for possible impairments. As the result, performing all required testing may take a long time.

Accordingly, it may be understood that there may be significant problems and shortcomings associated with current solutions and technologies for testing cable TV networks.

### SUMMARY

Accordingly, the present disclosure relates to a method and apparatus for simultaneous testing of upstream (US) and downstream (DS) signals and services in a cable TV network. The method may be implemented in an apparatus comprising two cable ports for connecting simultaneously to upstream and downstream portions of the cable TV network, and may include auto-detection of port connections.

According to one aspect of the present disclosure, there is provided a method for testing a cable network with a cable network tester comprising two cable ports, the cable network supporting a downstream signal and an upstream signal. The method comprises: a) receiving the downstream network signal at one of the two cable ports of the cable network tester; b) receiving the upstream network signal at the other of the two cable ports of the cable network tester; c) processing the downstream network signal to obtain downstream measurement data; d) processing the upstream signal to obtain upstream measurement data; and e) configuring the upstream measurement data and the downstream measurement data for simultaneous display to a user.

According to an aspect of the present disclosure, the method may be implemented in the cable network tester which comprises a first signal processing circuit configured for processing the downstream signal and a second signal processing circuit configured for processing the upstream signal, with the two cable ports comprising a first cable port and a second cable port, wherein c) comprises: c1) receiving, by the first signal processing circuit, a first signal from one of the first and second cable ports; c2) determining, by the first signal processing circuit, whether the first signal comprises the downstream signal; and c3) generating a ‘port switch’ signal if the first signal does not comprise the downstream signal.

Another aspect of the present disclosure relates to an apparatus for testing a cable television network, comprising: two cable ports for connecting simultaneously to an upstream portion of the cable network for receiving an upstream signal and to a downstream portion of the cable network for receiving a downstream signal; a first signal processing circuit coupled to one of the two cable ports and configured to process the downstream signal and to obtain downstream measurement data; a second signal processing circuit coupled to the other of the two cable ports and configured to process the upstream signal to obtain upstream measurement data; and a processor communicatively coupled to the first and second signal processing circuits and configured to process the upstream measurement data and the downstream measurement data and to configure the upstream and downstream measurements data for simultaneous display to a user.

According to one feature of one or more embodiments disclosed herein, the apparatus may be configured to determine whether a first signal received into the first signal processing circuit from one of the two cable ports comprises the downstream signal, and to generate a port switch signal if the first signal does not comprise the downstream signal. The apparatus may further comprise a connection switch disposed to provide a switchable 2×2 connection from the two cable ports to the first and second signal processing circuits, and to switch said connection in response to receiving the port switch signal so as to provide automatic port routing.

### BRIEF DESCRIPTION OF THE DRAWINGS

Embodiments disclosed herein will be described in greater detail with reference to the accompanying drawings which represent preferred embodiments thereof, in which like elements are indicated with like reference numerals, and wherein:

FIG. 1 is a schematic block diagram of a portion of a cable network;

FIG. 2 is a schematic block diagram illustrating tester connection for simultaneous upstream and downstream signal testing in a cable network;

FIG. 3 is a flowchart generally illustrating a method for simultaneous upstream and downstream signal testing in a cable network using a cable network tester with two cable ports;

FIG. 4 is a schematic block diagram of a tester connection for simultaneous upstream and downstream signal testing at a subscriber tap;

FIG. 5 is a schematic block diagram of a two-port tester for simultaneous upstream and downstream signal testing in a cable network;

FIG. 6 is a flowchart illustrating a method for simultaneous upstream and downstream signal testing with automatic port connection detection;

FIG. 7 is a schematic block diagram of a two-port tester with automatic port switching for simultaneous upstream and downstream signal testing;

FIG. 8 is a flowchart illustrating one embodiment of a method for simultaneous upstream and downstream signal testing with automatic port connection detection and routing;

FIG. 9 is a schematic block diagram illustrating upstream and downstream signal processing circuits of the two-port cable network tester;

FIG. 10 is a schematic block diagram of upstream and downstream measurement sub-systems of the two-port cable network tester;

FIG. 11 is a schematic block diagram of a two-port tester for simultaneous upstream and downstream signal testing with a reflectometer for testing wiring integrity of a downstream network;

FIG. 12 is diagram representing an upstream ingress spectrum (top panel) displayed simultaneously with concurrently measured BER and MER downstream spectra by the two-port cable network tester;

FIG. 13 is diagram representing a display of the two two-port cable network tester simultaneously displaying real-time upstream ingress spectrum (top panel), downstream and upstream throughput, and packet-level DOCSIS performance parameters;

FIG. 14 is diagram representing a downstream ingress-under-the-carrier spectrum (top panel) displayed simultaneously with concurrently measured upstream ingress spectrum.

### DETAILED DESCRIPTION

In the following description, for purposes of explanation and not limitation, specific details are set forth, such as particular circuits, circuit components, techniques, etc. in order to provide a thorough understanding of the present disclosure. However, it will be apparent to one skilled in the art that aspects of the present disclosure may be practiced in other embodiments that depart from these specific details. In other instances, detailed descriptions of well-known methods, devices, and circuits are omitted so as not to obscure the description. The appearances of the phrase “in one embodiment” in various places in the specification are not necessarily all referring to the same embodiment, nor are separate or alternative embodiments mutually exclusive of other embodiments. Note that as used herein, the terms “first”, “second” and so forth are not intended to imply sequential ordering, but rather are intended to distinguish one element from another unless explicitly stated. The terms ‘scan’ or ‘spectral scan’ are used interchangeably and may refer to a measured spectrum of an RF signal characteristic, or to a process of obtaining such spectrum, and encompasses computing a spectrum from a time domain signal using a Fourier transform. Furthermore, the following abbreviations may be used:

HFC Hybrid Fiber-Coaxial

LAN Local Area Network

ASIC Application Specific Integrated Circuit

FPGA Field Programmable Gate Array

DSP Digital Signal Processor

QAM Quadrature Amplitude Modulation

CPE Customer Premises Equipment

CMTS Cable Modem Termination System

RF Radio Frequency

RAM Random Access Memory

ADC Analog to Digital Converter

DAC Digital to Analog Converter

DOCSIS Data Over Cable Service Interface Specification

BER Bit Error Rate

MER Modulation Error Rate

Exemplary embodiments described hereinbelow relate to a method and a related apparatus for simultaneous testing of upstream (US) and downstream (DS) signals and services in a cable TV network. The method may be implemented in a multi-function portable dual-port cable TV tester that can perform cable test functions known in the art, such as, for example, channel/frequency scan for active upstream and downstream channels, upstream channel demodulation and error analysis, etc.

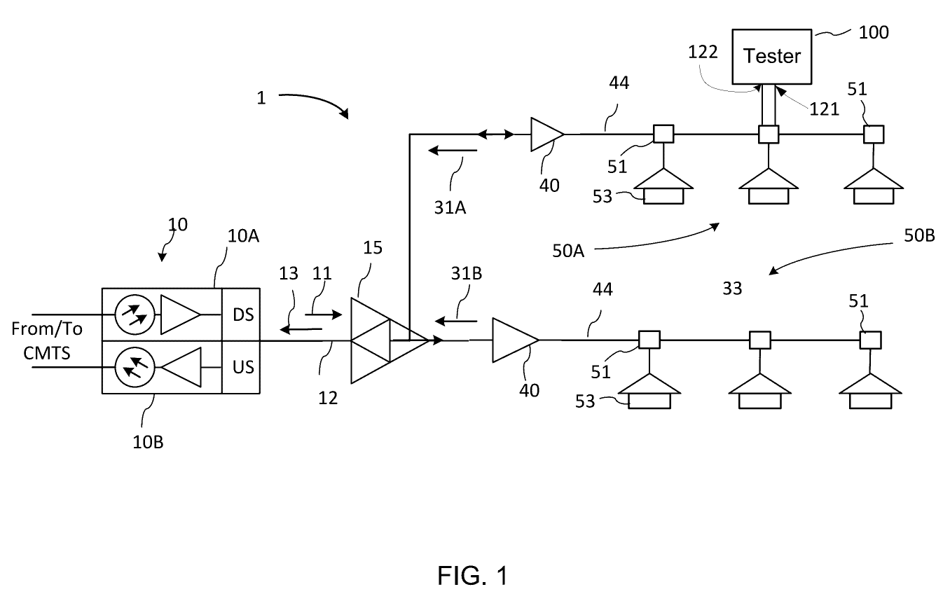

With reference to FIG. 1, there is shown a schematic diagram of an exemplary cable TV network 1 wherein embodiments of the present disclosure may be practiced. The exemplary cable TV network 1, which is also referred to herein simply as the cable network 1, may be a local portion of an HFC network that delivers Cable Television (CATV) signals, including digital TV signals and data and control signals, to end users. It will be appreciated however that methods and techniques described herein can also be used in other types of wired communication networks, such as for example DSL networks, possibly with modifications which would be evident to those skilled in the art on the basis of the present disclosure.

As illustrated in FIG. 1, a fiber-optic node 10 of the cable network 1 includes a downstream (DS) optoelectronic converter 10A that converts downstream (DS) optical signals generated by a remote CMTS (not shown) into downstream electrical RF signals 11, and an upstream (US) electro-optic converter 10B that converts upstream (US) electrical RF signals 13 into US optical signals for upstream transmission to the remote CMTS. The fiber-optic node 10 is coupled via a coaxial cable 12 to a bidirectional amplifier 15, which amplifies the downstream RF signals 11 for distribution to first and second groups of homes 50A and 50B. The downstream RF signals 11 generated by the downstream optoelectronic converter 10A of the fiber node 10 are distributed to a plurality of end-of-the-line subscribers, or end users, at customer premises or homes 53, via one or more trunk coaxial cables 44 and subscriber taps 51. At the customer premises 53, the DS signals are demodulated using cable modems (not shown). One or more two-way trunk RF amplifiers 40 may further be provided in each trunk cable 44 to suitably amplify the upstream and downstream CATV signals on their way to and from the subscriber premises 53. The first and second groups of homes 50A, 50B may send upstream signals 31A and 31B, respectively, which may be combined by the bidirectional amplifier 15 into the upstream RF signal 13 propagating towards the fiber node 10 for delivering to the remote CMTS at the headend (not shown). The cable network 1 may serve a large number of homes 53, which may be connected by taps 51 to a plurality of different cable trunks 44 at a plurality of different locations. The trunk cables 44 may be buried into the ground or they may be elevated above the ground on utility poles, or a combination of both.

An apparatus 100 for testing a cable television network may be connected to the cable network 1 at a desired test point where cable terminations for connecting separately to a downstream portion of the cable TV network and an upstream portion of the cable TV network, so that both upstream and downstream signals may be tested. The apparatus 100, which is also referred to herein as cable network tester 100 or simply as tester 100, includes two separate cable ports 121, 122, which may be referred to herein as the first (cable) port 121 and the second (cable) port 122. The first and second cable ports 121, 122 may be embodied using coaxial RF cable connectors. In one embodiment, tester 100 is a dual-port device. In other embodiments, additional cable ports may be provided as desired. It will be appreciated that tester 100 may also have other non-cable ports, for example to connect to a computer or to an external display, such as but not exclusively one or more USB ports and the like. Tester 100 may be, for example, in the form of a portable hand-held device.

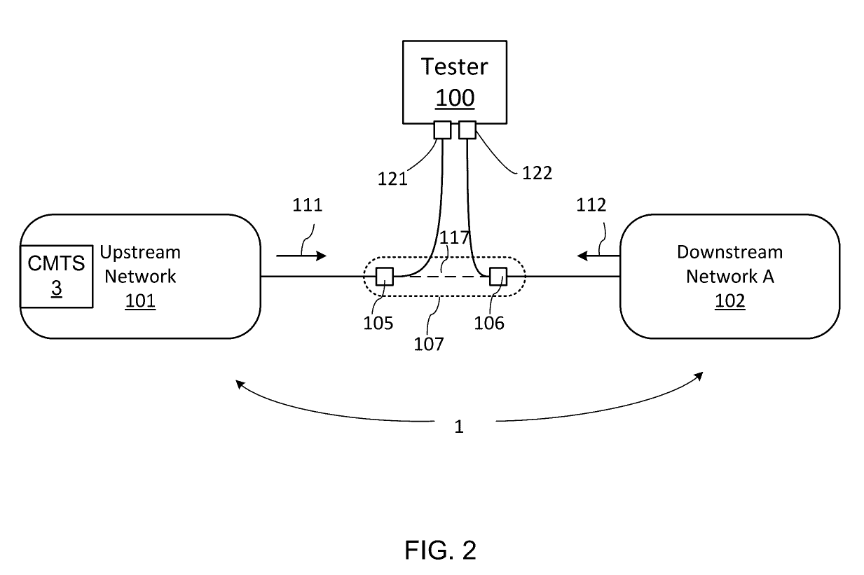

With reference to FIG. 2, the cable network 1 may be represented as an upstream (US) network portion 101 and a downstream (DS) network portion 102, which are connected at a node 107, as schematically illustrated in FIG. 2. The upstream network portion 101, which is also referred to herein as the upstream network 101 or the US network 101, may include a CMTS 3 generating downstream (DS) signals 111, while the downstream network portion 102, which is also referred to herein as the downstream network 102 or the DS network 102, may include a cable distribution network, or a portion thereof, that provides cable services to one or more homes which generate upstream (US) signals 112. Node 107 may be for example a fiber-to-coax node 10, a bi-directional RF amplifier 15 or 40, a subscriber tap 51, or any other suitable cable node that can provide cable connections to the upstream and downstream networks 101, 102. The node 107 may include an upstream cable terminal 105 and a downstream cable terminal 106, which are connected together during normal network operation, as illustrated in the figure by a dashed connection line 117, so that the US signals 112 can be delivered to the CMTS 3 in the upstream network 101, and the DS signals 111 may be delivered to the subscriber or subscribers in the DS network 102.

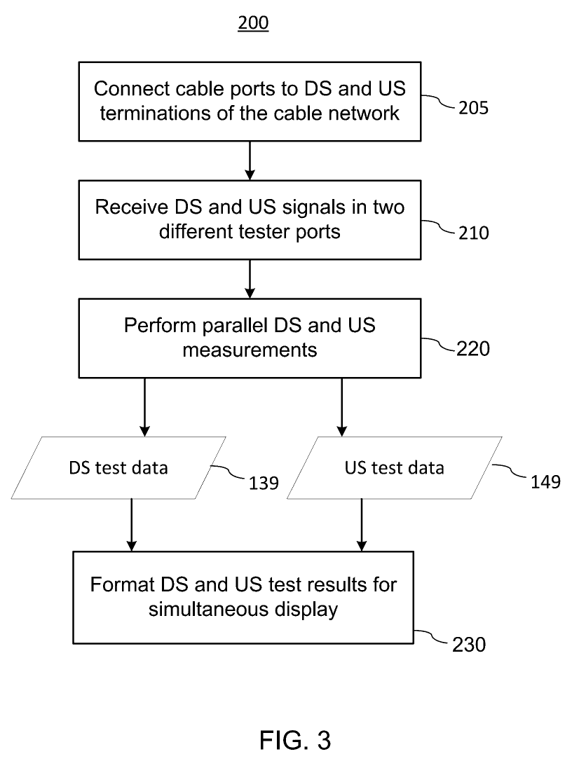

Referring also to FIG. 3, a method for testing cable network 1, or a portion thereof, using tester 100 is indicated generally by a reference numeral 200. In one embodiment, the method 200 starts at step 210 wherein tester 100 receives DS and US signals 111, 112 at two different cable ports 121, 122, once tester 100 is connected to the cable network 1 at node 107 in a preliminary step 205, wherein one of the cable ports 121, 122 of the tester 100 is connected to a cable termination 105 of the US network 101 and the other of the cable ports 121, 122 is connected to a cable termination 106 of the DS network 102, for example as illustrated in FIG. 2. At step 220, tester 100 processes the downstream (DS) and upstream (US) RF signals 111, 112, which are separately but concurrently received at ports 121, 122 of the tester 100, to obtain DS test or measurement data 139 and US test or measurement data 149; this step may include processing the DS signal 111 received from one of the two cable ports 121, 122 in parallel with processing the upstream (US) signal 112 received from the other of the two cable ports 121, 122. At step 230, tester 100 may configure the upstream measurement data and the downstream measurement data 139, 149 for simultaneous display in human perceptible form to a user.

Advantageously, by connecting one of the cable ports 121, 122 of the tester 100 to the US cable terminal 105 and the other of the cable ports 121, 122 to the DS cable terminal 106, the DS and US signals 111, 112 may be measured and analyzed concurrently, which makes technician's work more efficient by saving time and enabling direct comparison of network performance in DS and US paths.

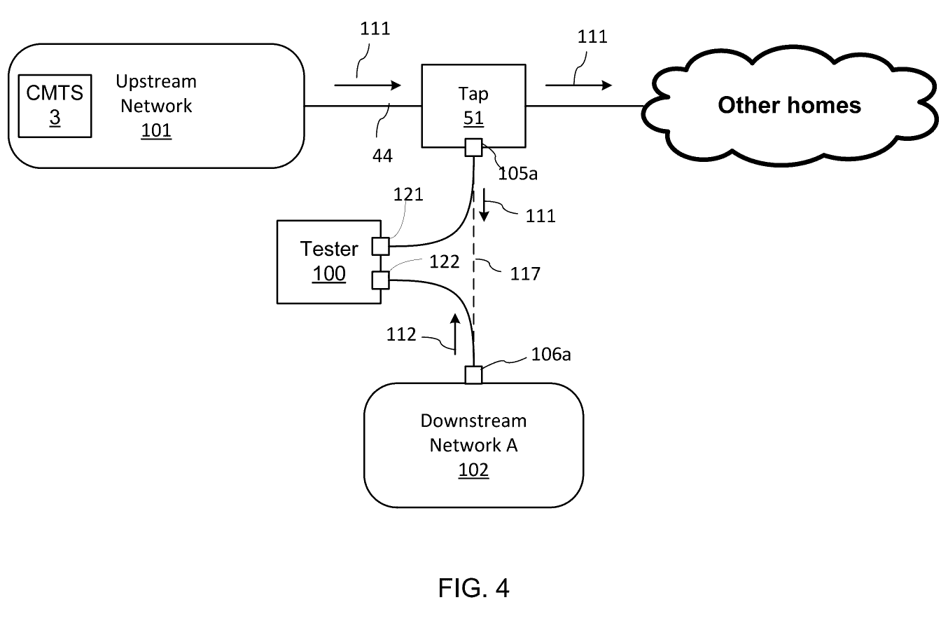

Referring now to FIG. 4, in one embodiment the upstream network 101 may be the service provide network while the downstream network ‘A’ 102 may be a customer residence network, which connects to the trunk cable 44 of the service provide network 1 via a subscriber tap 51. The first port 121 of the tester 100 may be connected to a cable drop 105a from the subscriber tap 51 to receive the downstream signals 111 from the CMTS 3 in the US network 101, and the second tester port 122 may be connected to a cable termination 106a of the customer residence network 102, for example at the cable ground box outside customer's house, to receive the US signals 112 generated by the CPE of the customer residence network 102. The customer residence network 102 is also referred to herein as the home network 102. Once connected at both ports 121 and 122, tester 100 may perform concurrent measurements i) on the DS signals 111 for testing incoming subscriber services, and ii) on the upstream signals 112 from the home network 102 for testing the customer residence network.

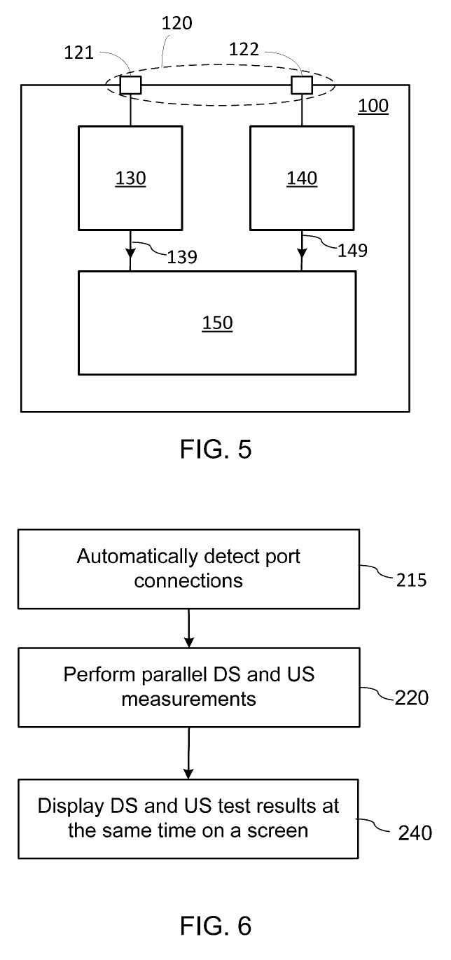

Exemplary embodiments of the tester 100 that is capable of performing concurrent measurements of the DS and US signals for testing respective DS and US services and presenting DS and US test results to a test technician simultaneously will now be described with reference to FIGS. 5-10.

Turning first to FIG. 5, in one embodiment tester 100 includes a network interface 120 providing the first and second cable ports 121, 122 for connecting simultaneously to an upstream portion of the cable network 1 and to a downstream portion of the cable network 1. A first signal processing circuit 130, which may be connected to the first cable port 121, is configured for processing the downstream signal 111 to obtain the downstream (DS) measurement data 139. A second signal processing circuit 140 is configured for processing the upstream signal 112 to obtain the upstream (US) measurement data 149; it may be connected to the second cable port 122. The first signal processing circuit 130 may be referred to herein as the DS signal processor 130, and the second signal processing circuit 140 may be referred to herein as the US signal processor 140. A control processor 150 may be communicatively coupled to the first and second signal processing circuits 130, 140 and configured to process the upstream measurement data 149 and the downstream measurement data 139 and to configure them for simultaneous display in human perceptible form, for example on a computer display of the tester 100. The US and DS signal processors 130, 140 and the control processor 150 may be embodied using a single dedicated or shared hardware processor or using multiple hardware processors, and/or a combination of software and hardware. Examples of hardware processors that may be used to implement blocks 112, 122, 150 include digital signal processor (DSP), Application Specific Integrated Circuit (ASIC), Field programmable Gate Array (FPGA), network processor, system on a chip such as an FPGA with integrated ARM or micro processor, Complex Programmable Logic Device (CPLD), Erasable programmable logic device (EPLD), Simple programmable logic device (SPLD), or macrocell array.

Referring now also to FIG. 6 while continuing to refer to FIG. 5, in one embodiment tester 100 may be configured to implement an embodiment of the method of FIG. 3 with an auto-detection of port connection, wherein tester 100 automatically detects, upon connecting one or both of the cable ports 121, 122 to one or both of the US and DS network cable terminals 105, 106, at which port the DS or US signal is received, and generates a ‘port switch’ control signal if an incorrect connection is detected, for example if port 121 is connected to the cable terminal 106 of the upstream network portion to receive the DS signal 111. In one embodiment, the ‘port switch’ control signal may be in the form, or include, a human perceptible signal, e.g. a signal that is visible on a screen of the tester or as a light indicator, and the user may manually change the port connections upon seeing or hearing the ‘port switch’ signal.

In one embodiment, tester 100 may further be configured to automatically direct, or rout, each of the DS and US signals 111, 112 received in the ports 121, 122 to a correct signal processor 130 or 140 once the cable ports 121, 122 are connected to the network cable terminals 105, 106, irrespectively to which of the two cable terminals 105, 106 each of the cable ports 121, 122 of the tester is connected. The connection auto-routing feature, which includes the port connection auto-detection, simplifies the process for the technician by eliminating the effort need for connecting the tester in a specific manner, thereby saving time needed for testing and improving the technician's efficiency.

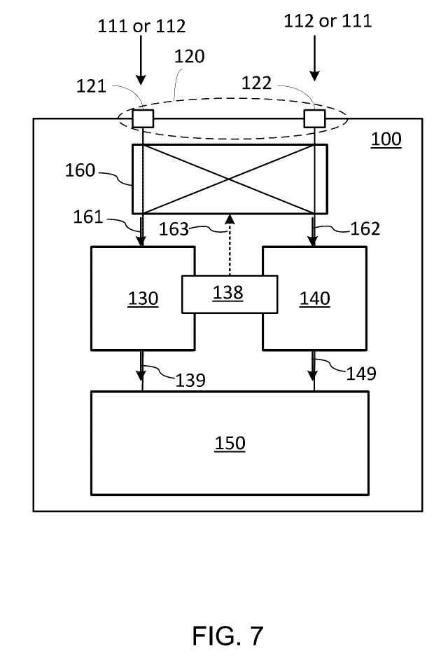

Referring to FIG. 7, there is illustrated an embodiment of tester 100 configured to implement the port auto-detection and auto-routing features. To that end, tester 100 includes a 2×2 connection switching circuit 160, which may also be referred to herein as the 2×2 connection switch 160 or as the port switch 160, and a connection detection logic 138, which may be coupled to, or comprised in, one or both of the DS and US signal processors 130, 140. The port switch 160 may be disposed operatively between the first and second cable ports 121, 122 on one side, and the first and second signal processing circuits 130, 140 on the other side, and may be configured for pair-wise connecting the first and second cable ports 121, 122 to the first and second signal processing circuits 130, 140 for supporting port auto-routing. The port switch 160 is switchable between two states: a first state wherein it connects the first port 121 to the DS processor 130 and the second port 122 to the US processor 140, and a second state wherein it connects the first port 121 to the US processor 140 and the second port 122 to the DS processor 130. The port switch 160 may be switched between these two states by a ‘port switch’ control signal 163 from one of the processors units 130, 140, or 150. Embodiments wherein the port switch 160 may be configured to have additional states may also be envisioned, for example wherein the port switch 160 connects one of the first and second signals processing circuits 130, 140 to either one of the two cable ports while leaving the other of the two signals processing circuits 130, 140 unconnected to any of the cable ports 121, 122.

Continuing to refer to FIG. 7, the operation of the connection auto-detection logic 138 may be based on known differences between typical DS and US signals, and may include detecting whether a signal received at one of the first and second cable ports 121, 122 has a particular characteristic that is generally specific to DS signals but not US signals, or vice versa, and then controlling the port switch 160 to direct the DS signal 111 to the DS processor 130, and to direct the US signal 112 to the US processor 140. For example, the presence of active carriers in one of the DS or US exclusive transmission bands may indicate whether the received signal is DS or US. In one embodiment, the connection detection logic 138 may be configured to: i) determine whether a first signal 161 that it receives from the port switch 160 includes a downstream signal, for example by scanning the RF energy it receives through the port switch 160 for active DS carriers, and ii) generate a port switch signal 163 for switching cable port connections in the 2×2 port switch 160 if the first signal 161 is not a downstream signal. For example, the DS signal may be distinguished from the US signal by the presence of video carriers, which are generally absent in the DS signal generated from a customer's residence, such as home. The connection detection logic 138 may utilize internal spectral analysis capabilities of the DS signal processor 130 and/or the US signal processor 140, as described hereinbelow more in detail. In some embodiments tester 100 may be absent of the port switch 160 but include the connection auto-detection logic 138 to provide the port auto-detection without the port connection auto-routing.

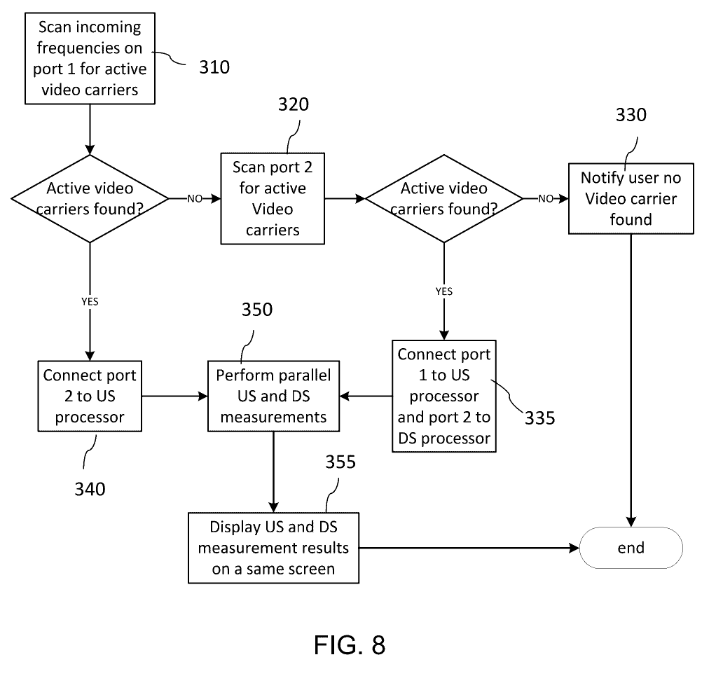

With reference to FIG. 8, in one embodiment tester 100 may be configured to carry out the following steps or operations to perform port connection auto-detection and auto-routing. At step 310, the port auto-detection logic 138 of tester 100 scans incoming frequencies received at the first port 121 for active video carriers; if no active video carriers is detected, incoming frequencies received at the second port 122 may then be scanned for active video carriers; if no active video carriers found in step 320, the port auto-detection logic 138 of tester 100 may generate a signal at step 330 to notify the user. If an active video carrier is found at step 320, the port switch 160 of the tester 100 is set at step 335 so that the first port 121 is connected to the US processor 140 and the second port 122 is connected to the US signal processor 130; at step 350, the DS and US signal processors 130, 140 of tester 100 perform parallel measurements on the US and DS signals 111, 112 respectively, with US and DS measurement results simultaneously displayed at step 355. Note that in one embodiment step 335 may be omitted, as the respective actions may be performed at step 320. If an active video carrier is found at step 310, the operation may proceed to step 350 directly, or through an intermediate step 340 wherein the second port 122 is connected to the US processor 140, if that connection had not been established earlier.

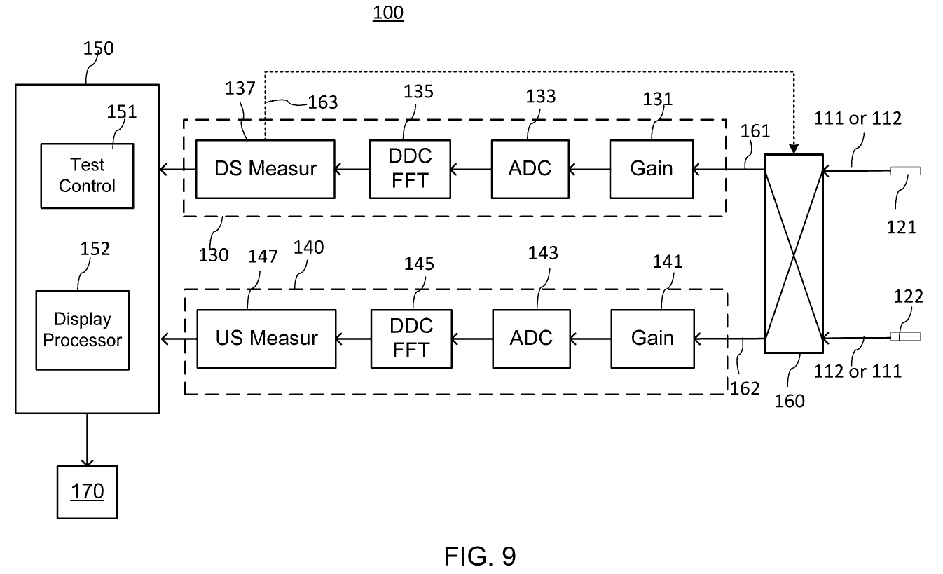

Turning now to FIG. 9, there is illustrated an exemplary embodiment of tester 100 in further detail. The port switch 160 may be omitted in some embodiments, as illustrated in FIG. 5. As illustrated, the DS signal processor 130 may include at its input a gain control unit 131, that is operationally followed by an ADC 133, a DDC/FFT logic 135, and a DS measurement logic 137. The gain control unit 131, which may be configured to adjust the power level of the first input signal 161 received from one of the cable ports 121, 122 of the tester, is optional. The DDC/FFT logic 135 may be configured to obtain a frequency spectrum of the digitized first signal 161 within the frequency band of DS transmission, for example by performing the FFT of the digitized first signal 161, and/or to tune to an active DS channel using digital down-conversion. The active DS channel to tune to may be selected, for example, by a user command or automatically by internal tester programming, and communicated to the DDC/FFT logic 135 by the control processor 150 and/or the DS measurement processor 137.

Similarly to the DS processor 130, the US processor 140 may include at its input an optional gain control unit 141 that is operationally followed by an ADC 143, a DDC/FFT unit 145, and a US measurement unit 147. Blocks 141, 143 and 145 of the US signal processor 140 are functionally similar to the respective blocks 131, 133 and 135 of the DS processor 130, except that the US DDC/FFT logic 145 may be configured to scan the RF energy it receives within the frequency band of US transmission, and/or to tune to an active US channel, which for example may be selected by a user command or automatically by the tester programming, and communicated to the DDC/FFT logic 145 by the control processor 150 and/or the US measurement processor 147. In one embodiment, the DDC/FFT unit 145 of the US signal processor 140 may be configured to scan the digitized signal it receives in the frequency band of the DS signal transmission, for example for the presence of DS signals such as active video carriers as described in step 320 of the method of FIG. 8.

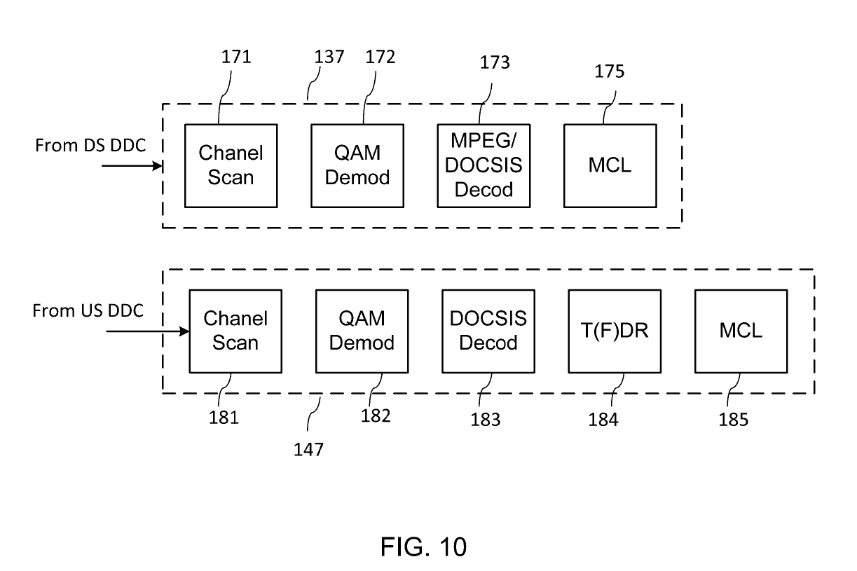

Referring also to FIG. 10, the DS measurement processor 137 may be configured to obtain DS measurement data 139 related to the downstream signal 111, including downstream diagnostic information, from the output of the DDC/FFT unit 135 and optionally by querying the ADC 133 and/or the gain control unit 131. The DS measurement data 139 may include frequency of each downstream channel detected in the downstream signal 161, and may also include downstream (DS) channel diagnostic information for one or more of the detected or active downstream channels. The DS channel diagnostic information may include at least one of the following channel parameters or characteristic: signal level of the detected downstream channel, a modulation type of the detected downstream channel, SNR for the detected downstream channel, BER for the detected downstream channel, MER for the detected downstream channel, Ingress under the carrier for the detected downstream channel, In Channel Frequency Response (ICFR) for the detected downstream channel, adaptive equalization coefficients for the detected downstream channel, Digital Quality Index (DQI) of the detected downstream channel. To this end, the DS measurement processor 137 may include channel scan logic 171 for controlling the DDC/FFT unit 135 and obtaining active channel data therefrom, and a QAM demodulator 172 for demodulating the selected DS channel; the QAM demodulator 172 may include an adaptive equalizer (not shown). The DS measurement processor 137 may further include an MPEG/DOCSIS decoder, which decodes demodulated signal received from the QAM demodulator 172. A measurement control logic (MCL) 175 in the DS measurement processor 137 may be configured to read various performance-related data from the MPEG/DOCSIS decoder 173, the QAM demodulator 172, and the channel scan control logic 171 to perform a variety of service level tests and to obtain the DS channel diagnostic information.

By way of example, the MCL 175 may be configured to use output from the DDC/FFT unit 135 for measurements of analog or digital channel level, downstream frequency response, I/Q Constellation plots, and ingress under the carrier. Alternatively, the two later measurements can be performed by querying the QAM demodulator 172. MCL 175 may also query control registers of the DDC/FFT unit 135 to obtain DDC gain values, which may then be used for computing carrier level parameters and the like. The MPEG/DOCSIS decoder 173 may have rate counters and packet error counters that may be read by MCL 175 to measure pre-FEC and post-FEC Bit Error Rate (BER), and MPEG data stream errors or error rates for the selected DS channel.

The channel scan logic 171 may be configured to operate, possibly under the control of MCL 175, as the connection auto-detection logic 138, or a portion thereof. For example, it may be configured to analyze the DS frequency spectrum data obtained from the DDC/FFT logic 135 for the presence of DS-specific channel information, such as the presence of active video carriers, and generate the ‘port switch’ signal 163 if no active carriers are found in the received signal.

Continuing to refer to FIGS. 9 and 10, the US measurement processor 147 may be configured to obtain US measurement data 149 related to the US signal 112, including upstream (US) diagnostic information, from the output of the DDC/FFT unit 145 and optionally by querying the ADC 143 and/or the gain control unit 141. The US measurement data 149 may include frequency of each US channel detected in the US signal 112, and may also include upstream (US) channel diagnostic information for one or more of the detected or active upstream channels. The US channel diagnostic information may include at least one of the following channel parameters or characteristic: signal level of the detected US channel, a modulation type of the detected US channel, SNR for the detected US channel, BER for the detected US channel, MER for the detected US channel, Ingress under the carrier for the detected US channel, In Channel Frequency Response (ICFR) for the detected US channel, adaptive equalization coefficients for the detected US channel, Digital Quality Index (DQI) of the detected US channel. To this end, the US measurement processor 147 may include a frequency or channel scan logic 181 for controlling the DDC/FFT unit 145 and obtaining active channel data therefrom, and a QAM demodulator 182 for demodulating the selected US channel; the QAM demodulator 182 may include an adaptive equalizer (not shown). The US measurement processor 147 may further include a DOCSIS decoder 183, which decodes demodulated signal received from the QAM demodulator 182. A measurement control logic (MCL) 185 in the US measurement processor 147 may be configured to read various performance-related data from the DOCSIS decoder 183, the QAM demodulator 182, and the channel scan control logic 181 to perform a variety of service level tests and to obtain the US channel diagnostic information using known in the art algorithm, as generally described hereinabove with reference to the DS measurement processor 137.

The channel scan logic 181 may be configured to operate, possibly under the control of MCL 185, as the connection auto-detection logic 138, or a portion thereof. For example, it may be configured to analyze the frequency spectrum data obtained from the DDC/FFT logic 145 for the presence of DS-specific channel information, such as the presence of active video carriers, and generate a ‘no video carriers found’ signal if no active carriers are found in the signal received by the US signal processor 140.

The US measurement processor 147 may further include network discovery logic (not shown) configured to test for the presence and configuration of home networking technology in the subscriber network 102. That may include for example, testing for the presence of MoCA (Multimedia Over CoAx) devices in the subscriber network. In one embodiment, the network discovery logic may look for an active MoCA network by searching the US frequency spectrum for a communication signal specific to a particular home network technology; for example, it may search for a MoCA communications signal. If a MoCA signal is present, tester 100 may join the MoCA network and report information about other MoCA connected devices in the MoCA network including but not limited to MAC addresses, physical layer (PHY) rate information, data rate information, and signal quality. Identifying active home networks such as MoCA is important since many home networking protocols are open and shared, therefore service providers may want to identify their presence and filter or block them from sharing with neighboring residences. Additionally, it is beneficial for operators to identify the quality of the home networking connection to ensure proper delivery of services to the devices in the home.

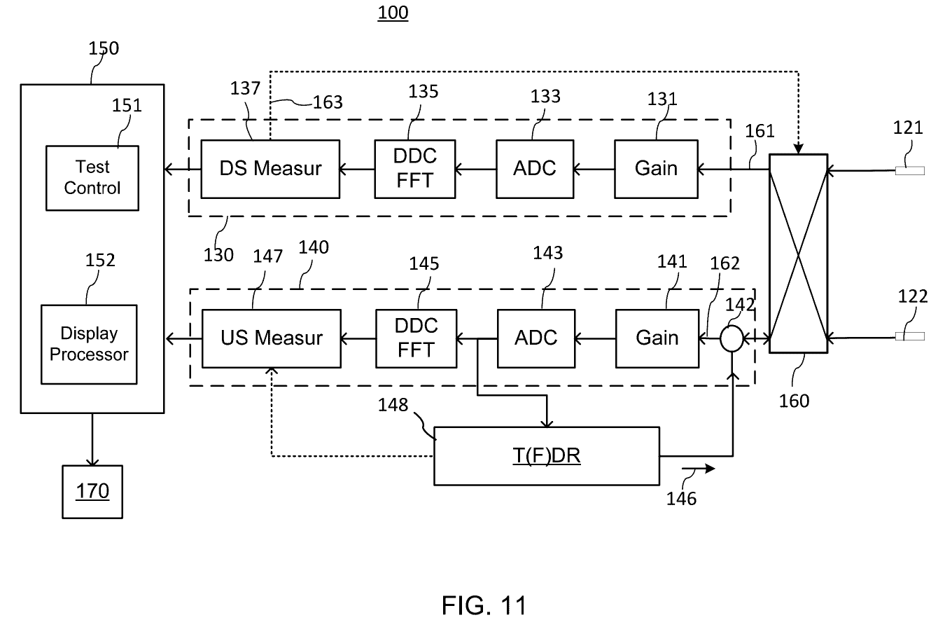

Referring now to FIG. 11, in one embodiment tester 100 may be configured to test wiring integrity of the subscriber's network 102. To that end, it may include a reflectometer 148, such as a time-domain reflectometer (TDR) or a frequency domain reflectometer (FDR). The reflectometer 148 may be coupled to the US processing circuit 140, or may be a part thereof; principles of operation and possible implementations of TDR and FDR are known in the art. The reflectometer 148 may be configured to inject a probe signal 146 into the subscriber network 102 through a coupler or switch 142 and one of the ports 121, 122 that is connected to the subscriber's network, and to process a digitized echo of the probe signal received from the subscriber's network 102 to detect wiring faults therein. In this embodiment, the US measurement processor 147 may include a reflectometer control logic for controlling the operation of the reflectometer 148 and processing measurement results related to the wiring integrity of the downstream network.

Referring to FIGS. 9, 11 and 12, the control processor 150 may include a test controller 151 that may be communicatively coupled to the DS signal processing circuit 130 and the US signal processing circuit 140, and configured for controlling computations required for extracting the DS and US diagnostic information from signals received in the cable ports 121 and 122, including controlling the demodulation and RF spectra computation. The test controller 151 may for example keep track of available and active US and DS channels in the cable network, for example by maintaining a channel list of channels to be tested, and active channels detected; it may also generate specific test commands to the DS and US signal processors 130, 140, for example in response to a user input.

The control processor 150 may be configured to process the US and DS measurement data 139 and 149, including the upstream and downstream channel diagnostic information, for simultaneous displaying on a display device 170. To that end, the control processor 150 may include a display control processor (DCP) 152 communicatively coupled to the measurement controller 151. The display device 170 may be communicatively coupled to the display processor 152. For example, it may be an LCD device built into tester 100, or it may be any other suitable display device. It should be appreciated that the display device 326 may be optional because an external device, such as a handheld tablet computer, may be used to communicate with the tester 100, e.g. via a Bluetooth™ link, and to concurrently display DS and US test results.

The DCP 152 may be configured to simultaneously display selected DS and US measurement data, as may be selected by the user, including signal spectra, demodulation parameters, performance indices, etc. Also, it should be appreciated that the DCP 152 may be configured to simultaneously display the frequency spectra and the demodulation parameters or other channel diagnostic information measured concurrently for US and DS signals. Thus, US frequency spectra and/or demodulation parameters may be directly compared to the concurrently measured US frequency spectra and/or demodulation parameters. This configuration may be advantageously used to troubleshoot intermittent errors. By simultaneously displaying the US and DS sides of the network performance at the test location, the subscriber's services may be tested and analyzed faster, and possible root causes of performance degradation discovered more efficiently.

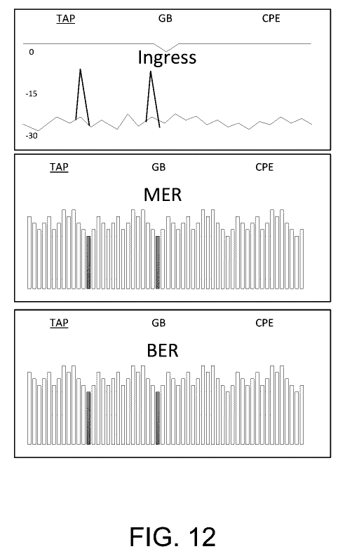

With reference to FIG. 12, the DCP 152 may be configured to simultaneously display, either responsive to the user selection or automatically upon completion a test program, an upstream frequency spectrum computed from the RF signal received from the house, and a spectral scan of DS channel quality. In the illustrated example, the top panel shows the US ingress scan, i.e. the spectrum of the RF signal originating from the subscriber premises, or “the house”, while the middle and the bottom panels of the display show the MER and BER channel values, respectively, vs. channel frequency for all active channels tested by the DS processor 130. The simultaneous display of these characteristics enables the technician to discover possible correlations between upstream ingress signals, or noise, from the house and deterioration in DS signal quality of particular channels. In the shown example, two channels with the lowest BER and MER values, which are shown in grey, visibly correlate in frequency with the upstream ingress, indicating possible causal relationship.

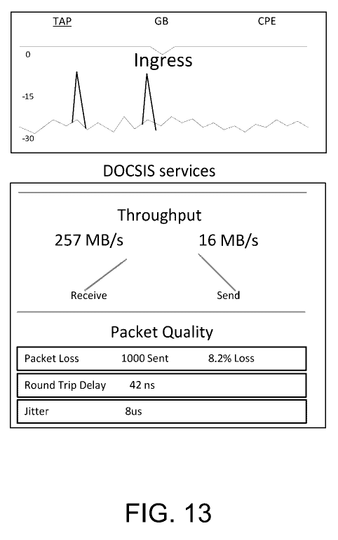

With reference to FIG. 13, the DCP 152 may be configured to display, either responsive to the user selection or automatically upon completion a test program, simultaneously an ingress frequency scan, either upstream or downstream, and DOCSIS signal quality parameters that were measured by the tester 100 concurrently with the ingress scan measurement. As illustrated, the top panel in the figure displays US ingress scan, and the lower panel displays concurrent DS and US throughput measurements, with packet-level signal quality parameters, such as packet loss, round-trip delay, and jitter displayed at the bottom. In one embodiment, the top panel may be switched between DS and US ingress spectral scans. The simultaneous display of concurrently measured noise (ingress) scan and DOCIS services quality enables to detect time correlations between US and/or DS signal degradation and DS and/or US noise.

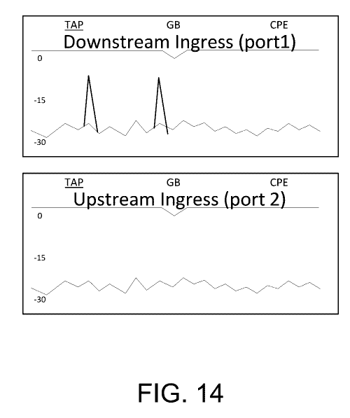

With reference to FIG. 14, the DCP 152 may be configured to simultaneously display, either responsive to the user selection or automatically upon completion a test program, the US frequency spectra computed from the RF signal received from the house, and the downstream Ingress under carrier and off-air ingress spectrum. The characteristics may be displayed, for example, in a split-screen configuration optionally indicating the port at which the respective signal is received, as illustrated in the figure. In FIG. 9, the top panel of the display shows the DS ingress under the carrier spectrum that is labeled “Upstream Ingress (port 2)”, while the US frequency scan, i.e. the RF spectrum received from the subscriber's premises, or “house”, is shown in the lower panel and labeled as “Downstream Ingress (port 1)”. Simultaneously displaying the ingress scan from the house and the downstream ingress under the carrier scan with off-air ingress scan enables a technician to compare them directly and see where the noise is occurring. Since ingress and noise are intermittent, it is beneficial to perform and display these measurements simultaneously to eliminate false readings.

It will be appreciated that the control processor 150, the DS and US measurement processors 137, 147, and the DDC/FFT units 135, 145 are functional units and may be may be embodied using a single dedicated or shared hardware processor or using multiple hardware processors, and/or a combination of software and digital hardware. Examples of hardware processors that may be used to implement blocks 112, 122, 150 include digital signal processor (DSP), Application Specific Integrated Circuit (ASIC), Field programmable Gate Array (FPGA), network processor, system on a chip such as an FPGA with integrated ARM or micro processor, Complex Programmable Logic Device (CPLD), Erasable programmable logic device (EPLD), Simple programmable logic device (SPLD), or macrocell array. In one exemplary embodiment, the control processor 150 and the DS and US measurement processors 137, 147 are implemented with a same hardware processor, such as a DSP, a suitable microcontroller, or a general purpose processor, that runs a software or firmware program or programs including computer instructions for performing one or more operations described hereinabove with reference to the DS and US measurement circuits 137 and 147 and the control processor 150, and the blocks 215, 220, and 230 in FIGS. 3 and 6, and blocks shown in FIG. 8. In one embodiment, this software program is executable by a hardware processor implementing the control processor 150 and is stored in a non-volatile memory (not shown) that is coupled to the hardware processor. In one embodiment, the DDC/FFT units 135 and 145 may be embodied as hardware logic, for example using an FPGA.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

Thus, the present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings, and such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

1. An apparatus for testing a cable network, comprising:
first and second cable ports connected to a node of the cable network, wherein the node of the cable network includes an upstream cable terminal and a downstream cable terminal, and wherein the first cable port is connected to the upstream cable terminal of the node of the cable network to receive an upstream signal, and the second cable port is connected to the downstream cable terminal of the node of the cable network to receive a downstream signal;
a first signal processing circuit coupled to the first cable port to process the upstream signal and obtain upstream measurement data concurrently with a second signal processing circuit coupled to the second cable port to process the downstream signal and obtain downstream measurement data; and
a processor communicatively coupled to the first and second signal processing circuits to process the upstream measurement data and the downstream measurement data and to configure the upstream measurement data and downstream measurement data for simultaneous display to user.

2. The apparatus of claim 1, wherein the first signal processing circuit is to determine whether a first signal received by the first signal processing circuit from the first cable port comprises the upstream signal, and if the first signal does not comprise the upstream signal, to generate a port switch signal to couple the first signal processing circuit to the second cable port.

3. The apparatus of claim 2, further comprising a connection switch disposed to provide a switchable 2×2 connection from the first and second cable ports to the first and second signal processing circuits, and to switch said connection in response to receiving the port switch signal.

4. The apparatus of claim 2, wherein the first signal processing circuit is to obtain a frequency spectrum of the first signal, to determine the presence or absence therein of at least one downstream channel, and to generate the port switch signal in the absence of downstream channels in the frequency spectrum of the first signal is determined.

5. The apparatus of claim 1, further comprising a computer display, wherein:
the first signal processing circuit is to obtain an upstream frequency spectrum from the upstream signal,
the second signal processing is to obtain a downstream frequency spectrum from the downstream signal, and
the processor is to process the upstream and downstream frequency spectra for simultaneous displaying on the computer display.

6. The apparatus of claim 1, wherein the second signal processing circuit is to obtain downstream diagnostic information comprising at least one of: frequency of a downstream channel detected in the downstream signals, signal level of the downstream channel, modulation type of the downstream channel, SNR of the downstream channel, BER of the downstream channel, MER of the downstream channel, Ingress under the carrier for the downstream channel, in-channel frequency response (ICFR) of the downstream channel, adaptive equalization coefficients of the downstream channel, Digital Quality Index (DQI) of the downstream channel, and downstream throughput.

7. The apparatus of claim 6, wherein the first signal processing circuit is to obtain upstream diagnostic information comprising at least one of: frequency of an upstream channel detected in the upstream signal, signal level of the detected upstream channel, modulation type of the detected upstream channel, SNR of the detected upstream channel, BER in the detected upstream channel, in-channel frequency response of the detected upstream channel, equalizer coefficients of the detected upstream channel, and upstream throughput, and
wherein the processor is to process the upstream and downstream diagnostic information for simultaneous displaying on a computer display.

8. The apparatus of claim 7, wherein the downstream portion of the network comprises a home network, and wherein the second signal processing circuit comprises a reflectometer for testing wiring integrity of the home network, wherein the upstream diagnostic information comprises information related to the wiring integrity of the home network, and wherein the processor is to process the information related to the wiring integrity of the home network for displaying simultaneously with the downstream diagnostic information.

9. The apparatus of claim 7, wherein the downstream portion of the network comprises a home network, and wherein the second signal processing circuit is for testing the home network for information related to a home networking technology used in the home network, and wherein the processor is to process the information related to the home networking technology for simultaneous displaying with the downstream diagnostic information.

10. The apparatus of claim 7, wherein the processor is to process the downstream and upstream diagnostic information for simultaneously displaying variations thereof in real time.

11. A method for testing a cable network with a cable network tester comprising first and second cable ports, the cable network supporting a downstream signal and an upstream signal, wherein the cable network includes a node having an upstream cable terminal and a downstream cable terminal, the method comprising:
connecting the first cable port to the upstream cable terminal of the node of the cable network, and connecting the second cable port to the downstream cable terminal of the node of the cable network;
receiving the downstream network signal at the first cable port of the cable network tester;
receiving the upstream network signal at the second cable port of the cable network tester;
processing, by a first signal processing circuit, the downstream network signal to obtain downstream measurement data while concurrently processing, by a second signal processing circuit, the upstream signal to obtain upstream measurement data; and
configuring the upstream measurement data and the downstream measurement data for simultaneous display to a user.

12. The method of claim 11, wherein receiving the upstream signal and receiving the downstream signal are performed concurrently.

13. The method of claim 11, wherein the first and second signal processing circuits are parallel signal processing circuits.

14. The method of claim 11, wherein processing the downstream network signal comprises:
receiving, by the first signal processing circuit, a first signal from one of the first and second cable ports;
determining, by the first signal processing circuit, whether the first signal comprises the downstream signal; and
generating a ‘port switch’ signal if the first signal does not comprise the downstream signal.

15. The method of claim 14, wherein determining whether the first signal comprises the downstream signal comprises obtaining a first frequency spectrum of the first signal, and determining whether the first frequency spectrum comprises at least one downstream channel.

16. The method of claim 15, wherein generating a ‘port switch’ signal comprises switching port-circuit connections between the two cable ports and the first and second signal processing circuits in response to the ‘port switch’ signal.

17. The method of claim 11, wherein processing the upstream network signal comprises:
receiving, by the second signal processing circuit, a first signal from one of the first and second cable ports;
determining, by the second signal processing circuit, whether the first signal comprises the upstream signal; and
generating a ‘port switch’ signal if the first signal does not comprise the upstream signal.

18. The method of claim 11, comprising:
obtaining a downstream frequency spectrum from the downstream signal,
obtaining an upstream frequency spectrum from the upstream signal, and
configuring the upstream and downstream frequency spectra for simultaneous displaying on a computer display.

19. The method of claim 18, wherein the downstream frequency spectrum comprises ingress under the carrier spectrum.

20. The method of claim 11, further comprising displaying the upstream and downstream measurement data simultaneously on a display device.

21. The method of claim 20, comprising displaying variations in the upstream measurement data and downstream measurement data in real time simultaneously on the display device.
